(19) United States
(12) Patent Application Publication
(10) Pub. No.: US 2022/0134797 A1
(43) Pub. Date: May 5, 2022

(54) WRITING INSTRUMENT WITH PEN AND PENCIL

(71) Applicants: SURESH KONTI, LEWIS CENTER, OH (US); SIDRA KONTI, LEWIS CENTER, OH (US)

(72) Inventors: SURESH KONTI, LEWIS CENTER, OH (US); SIDRA KONTI, LEWIS CENTER, OH (US)

(21) Appl. No.: 17/519,542

(22) Filed: Nov. 4, 2021

Related U.S. Application Data
(60) Provisional application No. 63/204,956, filed on Nov. 4, 2020.

(51) Int. Cl. B43K 24/16; B43K 29/02; B43K 21/00; B43K 27/02; B43K 27/00

(52) U.S. Cl. CPC B43K 24/163; B43K 29/02; B43K 27/006; B43K 27/02; B43K 21/00

(57) ABSTRACT

A writing instrument includes a combination of a multi-color pen and a mechanical pencil.

### CROSS-REFERENCE TO RELATED APPLICATIONS

This application claims priority from the U.S. provisional patent application Ser. No. 63/204,956, filed on Nov. 4, 2020, which is incorporated herein by reference in its entirety.

### FIELD OF INVENTION

The present invention relates to a writing instrument, and more particularly, the present invention relates to a writing instrument having a pen, pencil, and eraser.

### BACKGROUND

Both pen and pencil are used as writing instruments. Certain people use both pen and pencil for day-to-day needs. These people carry both pen and pencil with them. Additionally, often a person may need both a pen and pencil for marking a document. The person must alternatively switch between pen and pencil. While carrying both and pencil can be troublesome, switching between the pen and pencil can be annoying. Moreover, the person may additionally need to carry an eraser. Carrying the pen, pencil, and eraser together can be a burden on the person.

Thus, a need is there for a combined instrument that has the functionality of a pen, eraser, and pencil.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a writing instrument combining a pen and a pencil.

It is another object of the present invention that the writing instrument also includes an eraser.

It is still another object of the present invention that the writing instrument is portable and can be carried in a pocket.

It is yet another object of the present invention that the writing instrument is economical to manufacture.

It is a further object of the present invention that the writing instrument has different color pen options.

It is still a further object of the present that the writing instrument has an aesthetic appearance and is ergonomic in grip.

In one aspect, disclosed is a writing instrument that combines a pen and pencil in a single instrument. Additionally, an eraser can also be provided in the instrument.

In one aspect, the disclosed writing instrument can be used to write in different colors including black, red, and blue. The pencil can be a mechanical pencil that can be refilled. The mechanical pencil can replaceable take the lead of a pre-defined size, such as 0.5 mm.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the writing instrument, according to an exemplary embodiment of the present invention.

FIG. 2 is an exploded view of the writing instrument shown in FIG. 1, according to an exemplary embodiment of the present invention.

FIG. 3 shows a cover of the writing instrument shown in FIG. 1, according to an exemplary embodiment of the present invention.

FIG. 4 is another view of the cover shown as shown in FIG. 3, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

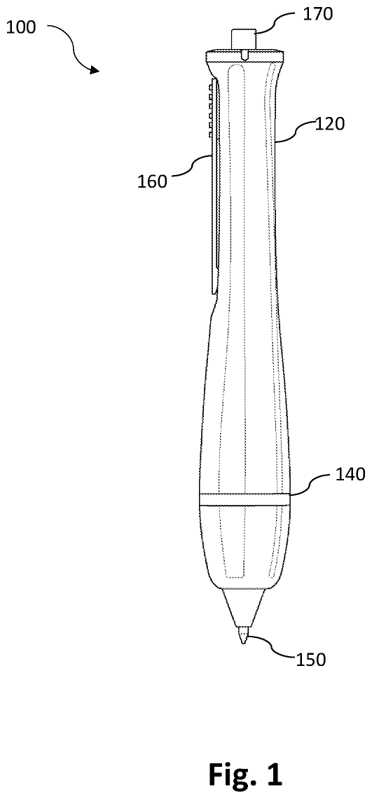

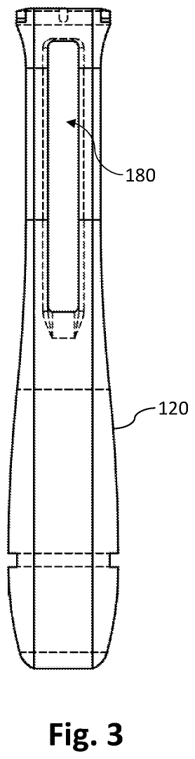

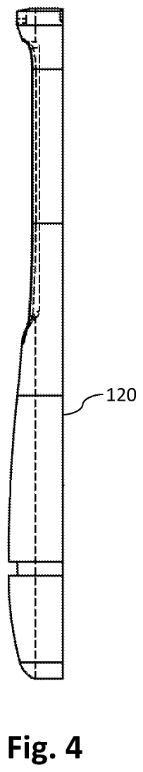

Disclosed is a writing instrument that combines a pen and mechanical pencil in a single writing instrument. The disclosed writing instrument can be switched between the pen and pencil. Moreover, an eraser can be provided concealed in the writing instrument. More than one cartridge of different color inks is also embodied, such as red, blue, and black ink cartridges. The mechanical pencil can changeably receive leads, wherein the size of lead can be defined. The disclosed writing instrument has an ergonomic grip and aesthetic appeal. A single writing instrument combines the functionality of the pen of different colors, pencil, and eraser that can be carried in a pocket, a case, and the like. Referring to FIGS. 1-4 which discloses an exemplary embodiment of the writing instrument. The writing instrument 100 includes a body 110, a cover 120, color pegs 130, and a decorative ring 140. The body 110 can include the integrated pen and mechanical pencil (not shown). The pen can include multiple ink color cartridges such as red, blue, and black. It is understood that the writing instrument can include one ink cartridge or more than one ink cartridge, wherein two or more cartridges can be of the same or different colors without departing from the scope of the present invention. The pen part of the body can include a nib 150 in fluid communication with one or more cartridges. In one case, one or more cartridges can have a common nib. Alternatively, each cartridge can have a nib, wherein the desired color cartridge can be selected.

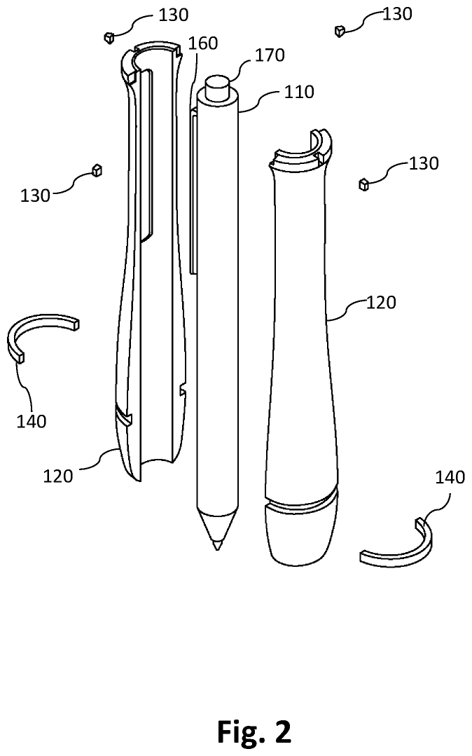

The disclosed body also includes a mechanical pencil wherein the writing instrument can be switched between the pen and the pencil. The mechanical pencil can receive leads of a predetermined size. A mechanism can be provided to switch between different cartridges and the mechanical pencil. FIGS. 1 and 2 shows pegs 130 as signs along which the mechanism can be operated to select the desired color cartridge or the mechanical pencil. In one case, the pegs can be colored to represent the color of the cartridge and indicate the mechanical pencil. For example, a blue color peg can correspond to a blue color cartridge. Peg corresponding to the pencil can be given a unique color, such as white or any unique design to distinguish it from others. The color pegs can be embedded in a cover 120, as shown in FIG. 1. The cover 120 can be manufactured in two parts that can snap-fit over the body. The parts can have interlocking members for securing the two-part cover over the body.

Also, a ring 140 can be seen in FIGS. 1 and 2 that can be disposed on the body 120 for aesthetic purposes. The body 110 of the writing instrument can also include an eraser at the top and be concealed by a cap 170. The cap can be removed from gaining access to the eraser that can be used to erase the pencil marks. It is understood that the cap can be optional, and any other mechanism can be used to conceal the eraser without departing from the scope of the present invention. The disclosed writing instrument can also be provided with a hook 160 to secure the writing apparatus in the pocket. The hook 160 can be implemented in the body, wherein the cover 120 can have a slot 180 for the hook 160.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A writing instrument comprising:
a body;
one or more ink cartridges in fluid communication with one or more nibs, the one or more ink cartridges encased in the body; and
a mechanical pencil encased in the body.

2. The writing instrument according to claim 1, wherein the writing instrument further comprises a mechanism to switch between the one or more ink cartridges and the mechanical pencil.

3. The writing instrument according to claim 1, wherein the writing instrument further comprises a cover encasing the body.

4. The writing instrument according to claim 3, wherein the cover has a first part and the second part, wherein the first part and the second part has an interlocking member for fastening the first part to the second part.

5. The writing instrument according to claim 4, wherein the one or more ink cartridges are three ink cartridges of colors red, blue, and black.

6. The writing instrument according to claim 5, wherein the writing instrument further comprises an eraser.

7. The writing instrument according to claim 6, wherein the writing instrument further comprises four pegs embedded in the cover, wherein the four pegs correspond to the three ink cartridges and the mechanical pencil respectively.

8. The writing instrument according to claim 7, wherein the four pegs are of different colors.

9. The writing instrument according to claim 7, wherein the mechanical pencil is configured to interchangeably receive a lead of a predetermined size.

10. The writing instrument according to claim 9, wherein the predetermined size is 0.5 mm.

11. A method for writing with pen or pencil, the method comprising the steps of:
providing a writing instrument comprising:
a body,
one or more ink cartridges in fluid communication with one or more nibs, the one or more ink cartridges encased in the body. and
a mechanical pencil encased in the body,
selecting an ink cartridge of the one or more ink cartridges; and
switching from the ink cartridge to the mechanical pencil.

12. The method according to claim 11, wherein the writing instrument further comprises a mechanism to switch between the one or more ink cartridges and the mechanical pencil.

13. The method according to claim 12, wherein the writing instrument further comprises a cover encasing the body.

14. The method according to claim 13, wherein the cover has a first part and the second part, wherein the first part and the second part has an interlocking member for fastening the first part to the second part.

15. The method according to claim 14, wherein the one or more ink cartridges are three ink cartridges of colors red, blue, and black.

16. The method according to claim 15, wherein the writing instrument further comprises an eraser.

17. The method according to claim 16, wherein the writing instrument further comprises four pegs embedded in the cover, wherein the four pegs correspond to the three ink cartridges and the mechanical pencil respectively.

18. The method according to claim 17, wherein the four pegs are of different colors.

19. The method according to claim 18, wherein the mechanical pencil is configured to interchangeably receive a lead of a predetermined size.

20. The method according to claim 19, wherein the predetermined size is 0.5 mm
